(19) United States
(12) Patent Application Publication
(10) Pub. No.: US 2021/0253224 A1
(43) Pub. Date: Aug. 19, 2021

(54) Weight-Shift Control (WSC)

(71) Applicant: Khaldoun L. Hameed, Baghdad (IQ)

(72) Inventor: Khaldoun L. Hameed, Baghdad (IQ)

(21) Appl. No.: 17/032,965

(22) Filed: Sep. 25, 2020

(51) Int. Cl. B64C 17/02; B64C 39/02; B64D 27/04; B64D 35/04; B64D 33/08; B64D 37/02

(52) U.S. Cl. CPC B64C 17/02; B64C 39/024; B64D 27/04; B64D 35/04; B64C 2201/108; B64D 37/02; B64C 2201/027; B64C 2201/044; B64D 33/08

(57) ABSTRACT

This present patent application discloses an unmanned aerial vehicle (UAV) that features a stable and easy way of steering and controlling the unmanned aerial vehicle. The unmanned aerial vehicle comprises of four vanes attached to extension arms, a single engine coupled to a special gearbox and sliding weights. The unmanned aerial vehicle features sliding weights below the extension arms and are used for steering the UAV in a desired direction in air. The sliding weights and the engine are used to control the UAV. The single engine leads to less power consumption, longer battery life, longer flight time and higher flight attitude.

### BACKGROUND

The present invention relates generally to the field of quadcopters. More specifically, the present invention relates to a method of steering and moving the quadcopters in the air with more stable and controllable way without changing the speed of the rotors. The quadcopter of the present invention uses an engine and a gearbox to deliver the kinetic energy to the system, thereby causing less power consumption, longer battery life and higher altitude for flight. The quadcopter utilizes movable or sliding weights on the body of the quadcopter for steering and controlling the quadcopter in a very easy, accurate and stable way. Accordingly, the present specification makes specific reference to the present invention. However, it is to be appreciated that aspects of the present invention are also equally amenable to other like applications, devices and methods of manufacture.

By way of background, a quadcopter or a multi-rotor helicopter drone (referred to herein as a “drone”) is an unmanned aerial vehicle an important tool for many fields of life such as aerial photography, providing first aid, shipping and delivery, wildlife monitoring, precision agriculture, disaster management, military and many other fields. The unmanned aerial vehicle uses a plurality of powered rotors for lift and propulsion. For example, a quad-copter, also called a quad-rotor helicopter or quad-rotor, is a drone that uses four powered rotors for lift and propulsion. Four different motors are attached to the four rotors for powering the rotors and changing their speeds, wherein two diagonal rotors rotate in a clockwise direction and other two diagonal rotors rotate in a counter-clockwise direction. When all the rotors spin together, the rotors push down on the air and the air pushes back up on rotors to initiate a flight of the quadcopter. Accordingly, when the rotors spin fast, the quadcopter lifts up into the air and when the rotors slow down, the quadcopter descends down towards ground. The speeds of rotors and their operation plays a major role in steering and controlling the quadcopter. The speed of the rotors is also varied to maintain a desired orientation (i.e., roll, pitch, or yaw) of the quadcopter. Controlling all the rotors through separate motors or engines causes large amount of power consumption, leading to short battery life and hence, short length flight.

Additionally, major problem with the conventional drones or quadcopters is the battery life. More specifically, use of multiple motors or engines for various rotors need more power to fly. For accommodating longer flights, batteries with large capacity is required which also increases the size and budget of the quadcopter. An increase in weight of the quadcopter due to the larger batteries affects the performance of the quadcopters. Further, charging of the larger capacity batteries is a time taking process and causes inconvenience to the users.

Typically, people face problems while using the drones for shipping and delivery, wildlife monitoring, disaster management, military and many other fields that requires the drone to be used for longer time. The major limit of the expanding of using quadcopters in many other fields because of the quadcopter fly time. The fly time depends on the battery life that should be chosen carefully in anticipation of its weight. Excessive use of the rotors for steering and controlling the drone for longer time leads to switching off of the drone and falling off on ground or water body in between the flight. In such a scenario, the drone is lost and the purpose remains incomplete without the use of the drone. This leads to inconvenience to the users and loss of the device as well.

Therefore, there exists a long felt need in the art for a quadcopter or drone that do not use separate motors for each of the rotors. There is also a long felt need in the art for a quadcopter that is controlled independent of the rotation of the rotors. There is also a long felt need in the art for a quadcopter that is steered independent of the speed of the rotors. There is a long felt need in the art for a quadcopter which is compact and lightweight. There is also a long felt need in the art for a quadcopter which supports higher altitude for the flight. Additionally, there is a long felt need in the art for a quadcopter that has longer battery life and therefore enables the quadcopter to cover longer distances. Finally, there is a long felt need in the art for a quadcopter that can be conveniently used by the users for various applications, uses single engine and a gearbox to provide kinetic energy to vanes of the quadcopter.

The subject matter disclosed and claimed herein, in one embodiment thereof, comprises a modified unmanned aerial vehicle (UAV) comprising a single engine coupled to a gearbox. The unmanned aerial vehicle features sliding weights on extension arms and are used for steering the UAV in a desired direction in air. The sliding weights and the engine are used to control the UAV without the need of manipulating the speeds of various rotors. The single engine leads to less power consumption, longer battery life, longer flight time and higher flight altitude.

In this manner, the modified quadcopter of the present invention accomplishes all of the forgoing objectives, and provides a relatively easy and efficient solution to control and steer the quadcopter according to the wants and needs of the user. The modified quadcopter of the present invention is also cost effective inasmuch as it utilizes a single engine. Finally, the modified quadcopter of the present invention provides a longer battery life, higher altitude flight and longer flight time.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a modified unmanned aerial vehicle (UAV) comprising a single engine coupled to a gearbox. The unmanned aerial vehicle features sliding weights on extension arms and are used for steering the UAV in a desired direction in air. The sliding weights and the engine are used to control the UAV without the need of manipulating the speeds of various rotors. The single engine leads to less power consumption, longer battery life, longer flight time and higher flight attitude.

The subject matter disclosed and claimed herein, in one embodiment thereof, comprises an unmanned aerial vehicle comprising an engine, four or more extension arms, four or more vanes attached to an end of each of the extension arms, sliding weights disposed under each of the extension arms, wherein the sliding weights are moved in a controlled way under the extension arm to slide the unmanned aerial vehicle in air in a direction as per the desire of a user. The unmanned aerial vehicle of the present invention operates in a manner to be independent of the speeds of the rotors and does not require multiple rotors and engines.

In yet another embodiment of the present invention, a quadcopter is disclosed. The quadcopter comprising an electric motor, a gearbox, four vanes attached to different extension arms, wherein the single electric motor powers the quadcopter, and sliding weights disposed on the extension arms. The gearbox provides kinetic energy to the vanes. The quadcopter is controlled and steered without changing the speeds of separate rotors and without requiring separate engines to power individual rotors. The quadcopter is steered by controlling the movement of the adjustable weights on each of the extension arms, thereby eliminating the method of using speed of rotors to change the direction of the quadcopter.

In yet another embodiment of the present invention, a method of controlling and driving quadcopter is disclosed. The method comprising: providing power to the quadcopter using a single engine, sliding weights disposed under extension arms of quadcopter to change the balance and therefore the direction of the quadcopter and providing kinetic energy to vanes by the gearbox coupled with the engine.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the quadcopter of the present invention in accordance with the disclosed architecture.

FIG. 2 illustrates a close-up view of an extension arm of the quadcopter of the present invention in accordance with the disclosed architecture.

FIG. 3 illustrates a top view of the quadcopter of the present invention in accordance with the disclosed architecture.

FIG. 4 illustrates a perspective of an extension arm of the quadcopter of the present invention having a special vane for Yaw rotation in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention or do not limit the scope of the invention. Additionally, an illustrated embodiment need not have all the aspects or advantages shown. Thus, in other embodiments, any of the features described herein from different embodiments may be combined.

As noted above, there exists a long felt need in the art for a quadcopter or drone that do not use separate motors for each of the rotors. There is also a long felt need in the art for a quadcopter that is controlled independent of the rotation of the rotors. There is also a long felt need in the art for a quadcopter that is steered independent of the speed of the rotors. There is a long felt need in the art for a quadcopter which is compact and lightweight. There is also a long felt need in the art for a quadcopter which supports higher altitude for the flight. Additionally, there is a long felt need in the art for a quadcopter that has longer battery life and therefore enables the quadcopter to cover longer distances. Finally, there is a long felt need in the art for a quadcopter that can be conveniently used by the users for various applications, uses single engine and a gearbox to provide kinetic energy to vanes of the quadcopter.

The innovative product of the present invention features a modified unmanned aerial vehicle (UAV) comprising a single engine coupled to a gearbox. The unmanned aerial vehicle features sliding weights on extension arms and are used for steering the UAV in a desired direction in air. The sliding weights and the engine are used to control the UAV without the need of manipulating the speeds of various rotors. The single engine leads to less power consumption, longer battery life, longer flight time and higher flight attitude.

FIG. 1 illustrates a perspective view of the quadcopter of the present invention in accordance with the disclosed architecture. The quadcopter 100 has four extension arms 160,161,162,163 each having vanes 140, 141, 142, 143 respectively. The extension arm 160 has a vane 140 at a far end 130 and a sliding weight 101, the extension arm 161 has a vane 141 at a far end 131 and a sliding weight 102, the extension arm 162 has a vane 142 at a far end 132 and a sliding weight 103 and the extension arm 163 has a vane 143 at a far end 133 and a sliding weight 104. The quadcopter 100 comprises a rotor 122 located inside a central structure or portion 120 of the quadcopter 100, an engine and a special gearbox. More specifically, the rotor 122 can preferably be positioned near or below the central portion 120 of the quadcopter 100. The quadcopter 100 of the present invention uses a novel steering and directing method that uses only one central rotor 122 which drives the four vanes 140,141,142,143 by using the special gearbox. The four sliding weights 101,102,103,104 slide towards the quadcopter center 120 and/or away from the quadcopter center 120 in a controlled manner to move the quadcopter 100 in a desired direction. The engine coordinates with the special gearbox to deliver the kinetic energy to the vanes 140,141,142,143.

The use of single central rotor 122 with power equal or near equal for the four rotors to lift the quadcopter 100 and transfer the kinetic energy to the four vanes 140,141,142,143 by using the special gearbox, reduces use of power and the battery life, and increases flight time of the quadcopter 100.

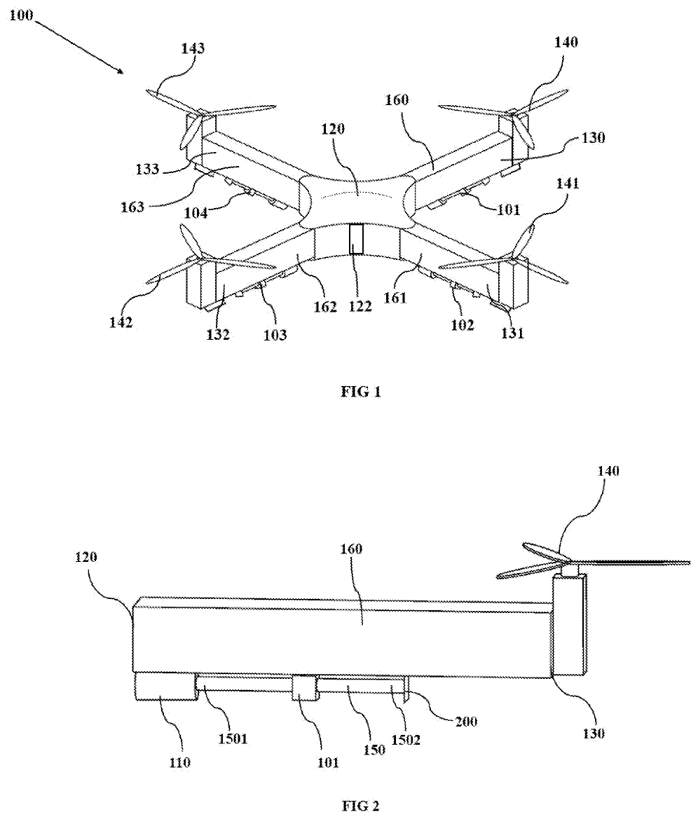

FIG. 2 illustrates a close-up view of an extension arm of the quadcopter of the present invention in accordance with the disclosed architecture. As shown in FIG. 2, a sliding weight 101 adapted to slide on a sliding mechanism such as guiding track 150 present under an extension arm 160. A stepper motor 110 is present near the centre 120 of the quadcopter 100 and a vane 140 is present near the far end 130 of the extension arm 160. The guiding track 150 may be an elongated rod structure having a first end 1501 and a second end 1502, wherein the first end 1501 is attached to the stepper motor 110 and the second end 1502 has a stopper 200. The stopper 200 is a square shaped structure to prevent the weight 101 from sliding out of the guiding track 150. The shape of the stopper is not limited and can be of any other shape. The weight 101 slides on the guiding track 150 between the first end 1501 and 1502 to steer and control the movement of the quadcopter 100.

The sliding of the weight 101 is controlled with small electric engines or stepper motor 110 to control forward and backward sliding along the guiding track 150 in order to change the balance of the extension arm 160 and the quadcopter 100. Similar sliding weights 102, 103, 104 are present in each of the other arms 161, 162, 163 respectively of the quadcopter 100 which slide along the respective rods to change the balance of quadcopter 100. Each of the sliding weights 101, 102, 103, 104 may be of same value or a higher or a lower value in weight.

The stepper motor 110 allows low-cost position measurement design for sliding weights and therefore eliminates the need for position detection sensors and closed-loop circuitry.

During operation, the sliding weights 101, 102, 103, 104 present on each of the four arms 160, 161, 162, 163 of the quadcopter 100 slide towards the center 120 and far away along the guiding track 150 from the center 120 of the quadcopter 100 causing the unbalanced position of the quadcopter 100 that moves and rotates the quadcopter 100 in a desired direction. The stepper motor 110 determines the position of the sliding weight 101 on the guiding track 150 according to a weight-distribution balance profile of the quadcopter 100 to maintain the desired movement for the operation of the quadcopter 100.

The sliding weights 101, 102, 103, 104 are selected based on the total weight of the quadcopter 100 and the external tools such as added payload or components, like a camera or lens or the like. The four weights 101, 102, 103, 104 disposed under the four extension arms 160, 161, 162, 163 of the quadcopter 100 is in the range of 10%-20% of the total weight quadcopter 100. It should be appreciated that weight proportion defined in the present invention causes efficient and safe steering and controlling of the quadcopter 100.

The sliding of the weights 101, 102, 103, 104 on the guiding tracks 150 of each of the extension arms 160, 161, 162, 163 adjusts a center of mass of the quadcopter 100 according to various embodiments. The weights 101, 102, 103, 104 are removably attached to the guiding tracks 150 and can be removed or changed as per the requirement of the user. In addition, the guiding tracks 150 may be a thick flat band, a bulkier tread (e.g., a tank tread), an elongated rod, a combination thereof, or another form of structure supporting sliding mechanism.

The stepper motor 110 may cause an actuator (not shown) to slide the sliding weight 101 in order to conform to the weight-distribution balance of the quadcopter 100. In some embodiments, the stepper motor 110 may cause an actuator to move the sliding weight 101 along a guiding track 150 between a plurality of weight-balance fixation positions.

The quadcopter 100 of the present invention can rotate in three different dimensions: roll, pitch, and yaw. Pitch is an axis that passes horizontally parallel to the plane of quadcopter extending towards the front and back end of the quadcopter. The pitch also means that the quadcopter tilts upwards or downwards based on its orientation and the location. A downwards tilt will move the quadcopter in a forward motion, while an upwards tilt will move it backwards. Roll is an axis that passes horizontally parallel to the plane of quadcopter extending from left to right. Roll moves the drone to the sides, causing it to “roll.” Further, it does not cause the quadcopter to change its altitude position. These “rolls” cause the quadcopter to move to the right and the left on its horizontal axis. Yaw is the vertical axis that passes through the geometric center of the quadcopter. The quadcopter rotates about the Yaw axis in a clockwise or a counter-clockwise direction.

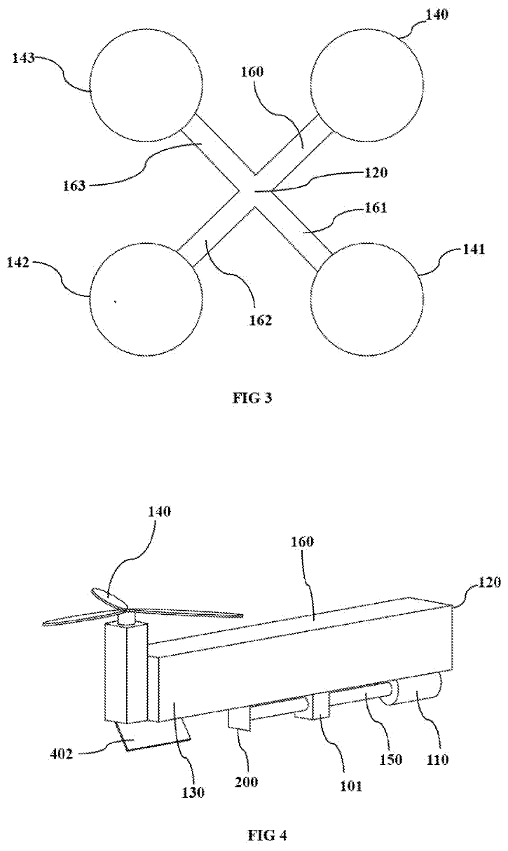

FIG. 3 illustrates a top view of the quadcopter of the present invention in accordance with the disclosed architecture. In the quadcopter 100 of the present invention, for the pitch, roll and yaw rotation, the weights 101, 102 or 103, 104 slides out far from the center 120 of the quadcopter 100 to make that side heavier. Any pair of the weights may be chosen by a user to direct the quadcopter in a specific direction. Accordingly, by sliding the left weights 103 and 104 together away from the center 120 and sliding right weights 101 and 102 weights together towards the center 120 of the quadcopter 100, the quadcopter 100 is moved towards the left direction. Similarly, by sliding the left weights 103 and 104 together towards the center 120 and sliding right weights 101 and 102 weights together away from the center 120 of the quadcopter 100, the quadcopter 100 is moved towards right direction.

To move the quadcopter 100 of the present invention in a forward direction, the front weights 101 and 104 are slide together away from the center 120 of the quadcopter 100 and back weights 102 and 103 are slide together towards the center 120 of the quadcopter 100. Similarly, to move the quadcopter 100 of the present invention in a backward direction, the back weights 102 and 103 are slide together away from the center 120 of the quadcopter 100 and front weights 101 and 104 are slide together towards the center 120 of the quadcopter 100.

The four sliding weights 101,102,103,104 slide towards the quadcopter center 120 and/or away from the quadcopter center 120 in a controlled manner to move the quadcopter 100 in a desired direction. The sliding weights 101,102,103,104 used in the quadcopter 100 of the present invention shall be controlled with small electric engines or stepper motors to move them over the guiding track, thereby causing a forward, backward, right and/or left movement of the quadcopter 100.

FIG. 4 illustrates a perspective of an extension arm of the quadcopter of the present invention having a special vane for Yaw rotation in accordance with the disclosed architecture. As shown in FIG. 4, for the yaw rotation, a special vane 402 is attached under the vane 140 at a far end 130 of an extension arm 160 of the quadcopter 100. The special vane 402 changes the direction of the drived-out air which rotates the quadcopter 100 around the yaw axis. Similarly, special vane 402 is attached under other vanes 141, 142 and 143 as well for changing the direction as per the desires of the user.

In one embodiment, the quadcopter 100 of the present invention may have a gasoline engine. In this proposed method of the present invention, accurate control of rotor's speed is no longer needed. The invention offers a new way for steering and moving the quadcopter 100, by changing the balance of the quadcopter 100 and giving the quadcopter 100 a horizontal power. By using balance steering, the need for four rotors is not required in the present invention. The quadcopter 100 has a longer flight time, higher altitude, increased battery life, high efficiency and effective and smooth flying capabilities.

The gasoline engine gives a higher altitude and speed to the quadcopter 100 and is more powerful than the electrical engine. The gasoline engine can be a 2-stroke or a 4-stroke engine. The gasoline engine used for the present invention is small, lightweight and efficient and is designed to deliver the same functionality as a traditional electric engine. The fuel used in the gasoline engine may be a nitrite-based fuel or ordinary gasoline such as unleaded gasoline or even the two stroke motor oils.

The size and power of the gasoline engine depends on the size of the body of the drone. The selection of gasoline engine also depends on the sliding weights present in the quadcopter. The gasoline engine increases mobility, allowing the user to move the quadcopter up or down quickly. The quadcopter with gasoline engine is relatively stable, even in strong winds.

In an alternate embodiment, to increase the power of the quadcopter, 2 or more gasoline two-stroke engines may be installed in the quadcopter. The engine may have electronic ignition, twin spark and fuel injection.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “unmanned aerial vehicle”, “drone”, “quadcopter” and “UAV” are interchangeable and refer to the quadcopter 100 of the present invention.

Notwithstanding the forgoing, the quadcopter 100 of the present invention can be of any suitable size and configuration as is known in the art without affecting the overall concept of the invention, provided that it accomplishes the above stated objectives. One of ordinary skill in the art will appreciate that the size, configuration and material of the quadcopter 100 as shown in the FIGS. are for illustrative purposes only, and that many other sizes of the quadcopter 100 are well within the scope of the present disclosure. Although the dimensions of the quadcopter 100 are important design parameters for user convenience, the quadcopter 100 may be of any size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An unmanned aerial vehicle comprising:
a single engine;
a gearbox;
four or more extension arms;
four or more vanes attached to an end of each of the extension arm;
sliding weights disposed on each of the extension arm;
the sliding weights are moved in a controlled way under the extension arm to move the unmanned aerial vehicle in air in a desired direction; and
wherein the engine drives the four vanes using the gearbox.

2. The unmanned aerial vehicle of claim 1, wherein the sliding weights are 16%-18% of the total weight of the unmanned aerial vehicle.

3. The unmanned aerial vehicle of claim 1, further comprises a weight distribution processor for adjusting a center of mass of the unmanned aerial vehicle.

4. The unmanned aerial vehicle of claim 1, wherein the movable weights are moved along the guiding tracks present under corresponding extension arm of the unmanned aerial vehicle.

5. The unmanned aerial vehicle of claim 1, wherein a gasoline engine provides 5-15 horsepower.

6. The unmanned aerial vehicle of claim 1, has a stronger power and longer flight time.

7. The unmanned aerial vehicle of claim 1, wherein the gearbox delivers the kinetic energy to the four vanes.

8. The unmanned aerial vehicle of claim 1, is a drone or a quadcopter.

9. The unmanned aerial vehicle of claim 1, wherein the single engine gives a time of flight of 2-30 hours.

10. The unmanned aerial vehicle of claim 1, wherein the single engine gives unmanned aerial vehicle an altitude of up to 2000 meters.

11. The unmanned aerial vehicle of claim 1, further comprising a cooling component disposed on one the engine, the cooling component being configured to cause dissipation of heat.

12. The unmanned aerial vehicle of claim 1, wherein less power is required to move the unmanned aerial vehicle with a single engine.

13. An unmanned aerial vehicle (UAV) comprising:
a gasoline engine;
sliding weights in the body for steering of the unmanned aerial vehicle;
using the gasoline engine to power the UAV;
wherein the power of gasoline engine is based on the size of the UAV and the sliding weights; and
steering of the UAV is independent of the engine speed.

14. The unmanned aerial vehicle of claim 13, wherein the sliding weights are moved in a controlled way under extension arms of the unmanned aerial vehicle to slide the unmanned aerial vehicle in air in a desired direction.

15. The unmanned aerial vehicle of claim 13, wherein the life of a battery and time of flight of unmanned aerial vehicle is increased.

16. The unmanned aerial vehicle of claim 13, wherein the gasoline engine is a 2-stroke engine.

17. The unmanned aerial vehicle of claim 13, additionally comprises a vessel for storing gasoline or a mixture of gasoline and oil mixture to power the unmanned aerial vehicle.

18. A method of controlling and driving a quadcopter, the method comprising:
providing, by a single engine, energy to power the quadcopter;
sliding movable weights disposed under extension arms of the quadcopter to change the balance of the quadcopter; and
providing kinetic energy to four vanes disposed on the far end of the extension arms of the quadcopter.

19. The method of claim 18, is performed by a 2-stroke or a 4-stroke gasoline engine.

20. The method of claim 19, wherein the steering of the UAV is independent of the engine speed.
